(19) United States
(12) Patent Application Publication
(10) Pub. No.: US 2014/0149266 A1
(43) Pub. Date: May 29, 2014

(54) STOCK SYSTEM

(71) Applicant: Matthew Poray-Pstrokonski, Moseley (GB)

(72) Inventor: Matthew Poray-Pstrokonski, Moseley (GB)

(21) Appl. No.: 14/089,919

(22) Filed: Nov. 26, 2013

(30) Foreign Application Priority Data
Nov. 28, 2012 (GB) 1221438.3

(51) Int. Cl. G06Q 10/08

(52) U.S. Cl. CPC G06Q 10/087
USPC 705/28

(57) ABSTRACT

A stock system which includes a stock management apparatus. The apparatus has an input device, a memory, an output device and a processor. The memory device includes a stock line data collection which relates to a stock line and has an identifier unique to the stock line, a cost item relating to the cost incurred per stock item and a stock level item. The processor has query processing means for generating the required gross profit item for the stock line from a desired stockturn item, the desired mark-up item, the cost item and the stock level item for the stock line.

### BACKGROUND OF THE INVENTION

1. Field of the Invention

The present invention relates to stock systems.

2. The Prior Art

Conventionally, stock systems include stock management apparatus to manage stock to ensure that stock line items are available in the right place, at the right quantity, at the right time. However, such apparatus is often poorly integrated with accounting packages. For example, management accountants have to provide forecasts for budgeting and profitability forecasts. Such forecasts are often and necessarily performed at a general level, and focus on absolute stock levels at certain fixed dates for accounting purposes and are not focused on providing data relating to the movement of stock in a form which is easily understandable and can feed into the forward planning of a business. When reviewing performance, it is often difficult to assess the performance of individual stock lines against a budget.

Conventionally, in one management system which is referred to as “Direct Product Profitability”, all of the direct costs associated with the handling and selling of a product are taken into account. Unfortunately this system is highly complex and difficult to maintain.

In another conventional system, referred to as “Gross Margin Return on Inventory Investment” (GMROI), product profitability is calculated in relation to the underlying investment in the product. However, this method only offers a means of comparing between products, and provides no correlation between product actual performance and the performance required by the Company Financial Plan.

### SUMMARY OF THE INVENTION

According to a first aspect of the present invention, there is provided a stock system, the system including stock management apparatus, the apparatus including:

an input device arrangement, a memory device, an output device arrangement and a processor device;

the memory device including a stock line data collection, the stock line data collection relating to a stock line;

the stock line data collection including an identifier item unique to the stock line, a cost item relating to the cost incurred per stock item in the stock line and a stock level item relating to the number of stock line items in the stock line at a predetermined place, time and date,

the memory device including a desired performance data collection which includes a desired stockturn item and a desired mark-up item;

the memory device including an output data collection including, for the stock line, a required gross profit item;

the processor device including query processing means for generating the required gross profit item for the stock line from the desired stockturn item, the desired mark-up item, the cost item and the stock level item for the stock line;

the processor device including output processing means for causing the output device to output the output data collection.

Possibly, the cost item, the stock level item, the desired stock turn item and the desired mark-up item comprise numerical values.

The stock line data collection may relate to the stock line over a predetermined time period.

Possibly, the query processing means include a first set of instructions, which may generate the required gross profit for the stock line by performing a calculation in which the values of the cost item, the stock level item, the desired stock turn item and a profitability parameter based on the desired mark-up item are multiplied together.

Possibly, the stock line data collection includes an actual sales item, which may be a numerical value, which may relate to the actual sales achieved of the stock line in a predetermined period.

Possibly, the stock line data collection includes an actual price item, which may be a numerical value, which may relate to the actual price achieved of the stock line in the predetermined period.

Possibly, the query processing means include a second set of instructions, which may generate an actual gross profit item for the stock line in the predetermined period by performing a calculation including the cost item, the actual price item and the actual sales item.

Possibly, the output data collection includes, for the stock line, the actual gross profit item, which may be a numerical value.

Possibly, the query processing means include a third set of instructions, which may generate a gross profit variance item for the stock line by performing a calculation including the required gross profit item and the actual gross profit item.

Possibly, the output data collection includes, for the stock line, the gross profit variance item, which may be a numerical value.

Each stock line data collection may include a plurality of period stock line data collections, each of which may relate to a different predetermined time period.

Possibly, the memory apparatus includes a plurality of stock line data collections. Each stock line data collection may relate to a different stock line.

Possibly, the stock system includes an upstream stock source, a stock holding, and a downstream stock destination. Possibly, the input device arrangement comprises a first reader located between the upstream stock source and the stock holding. Possibly, the input device arrangement comprises a second reader located between the stock holding and the downstream stock destination.

Possibly, the apparatus includes one or more stock line items, which may be movable in use between the upstream stock source and the stock holding via the first reader and may be movable between the stock holding and the downstream stock destination via the second reader.

According to a second aspect of the present invention, there is provided a method of managing stock in a stock system, the method including providing a stock system including stock management apparatus, the apparatus including:

an input device arrangement, a memory device, an output device arrangement and a processor device;

the memory device including a stock line data collection, the stock line data collection relating to a stock line;

the stock line data collection including an identifier item unique to the stock line, a cost item relating to the cost incurred per stock item in the stock line and a stock level item relating to the number of stock line items in the stock line at a predetermined place, time and date,

the memory device including a desired performance data collection which includes a desired stockturn item and a desired mark-up item;

the memory device including an output data collection including, for the stock line, a required gross profit item;

the processor device including query processing means for generating the required gross profit item for the stock line from the desired stockturn item, the desired mark-up item, the cost item and the stock level item for the stock line;

the processor device including output processing means for causing the output device to output the output data collection.

Possibly, the method includes any of the features or steps described in the previous paragraphs.

Possibly, the stock system includes any of the features or steps described in the previous paragraphs.

According to a third aspect of the present invention, there is provided a stock management computer program, the program comprising computer program code means which, when loaded into a processor device, causes the processor device to perform as part of the above described system, apparatus or method.

According to a fourth aspect of the present invention, there is provided a computer program as described above, embodied on a computer readable medium, which, when loaded into a processor device causes the processor device to perform as part of the above described system, apparatus or method.

### BRIEF DESCRIPTION OF THE DRAWINGS

Embodiments of the present invention will now be described, by way of example only, and with reference to the accompanying drawings, in which:

FIG. 1 is a schematic view of a stock system;

FIG. 2 is a schematic block diagram of the stock system of FIG. 1; and

FIG. 3 is a schematic view of an output data collection of the stock system of FIG. 1.

### DETAILED DESCRIPTION OF THE PREFERRED EMBODIMENTS

In this specification, the term “stock line” is used to denote a type of stock unit (also referred to as a stock keeping unit or SKU).

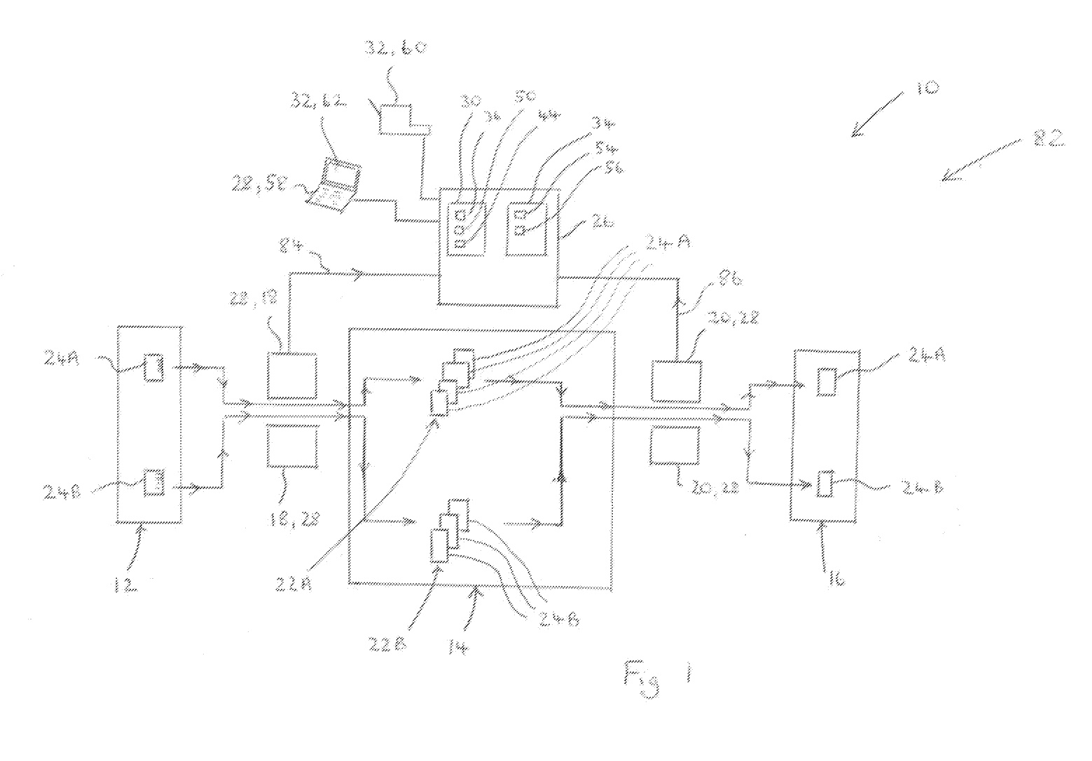

FIGS. 1 to 3 show a stock system 82, the system 82 including stock management apparatus 10, the apparatus 10 including: an input device arrangement 28, a memory device 30, an output device arrangement 32 and a processor device 34.

The memory device 30 and the processor device 34 form part of a computer 26.

The system 82 includes an upstream stock source 12, a stock holding 14, and a downstream stock destination 16. The input device arrangement 28 comprises a first reader 18 located between the upstream stock source 12 and the stock holding 14. The input device arrangement 28 comprises a second reader 20 located between the stock holding 14 and the downstream stock destination 16.

The input device arrangement 28 could include other input devices, such as, for example, a keyboard 58.

The output device arrangement 32 could comprise a display 62 and/or a printer 60.

In this example, the system 82 includes two stock lines 22A, 22B comprising stock line items 24A, 24B respectively, which are movable between the upstream stock source 12 and the stock holding 14 via the first reader 18 and between the stock holding 14 and the downstream stock destination 16 via the second reader 20. In the following, the stock lines may be referred to with the generic reference 22 and the stock line items with the generic reference 24.

In one example, the stock holding 14 could be located in a retail store. The upstream stock source 12 could be a distribution warehouse or a manufacturing facility. The downstream stock destination 16 could be a customer's location.

The first and second readers 18, 20 are arranged to read a code carried by each stock line item 24 passing thereby and update the system 82 accordingly. The readers 18, 20 could, for example, comprise bar code readers or RFID tag readers. The code could include an identifier item 38 which is unique to the particular stock line 22.

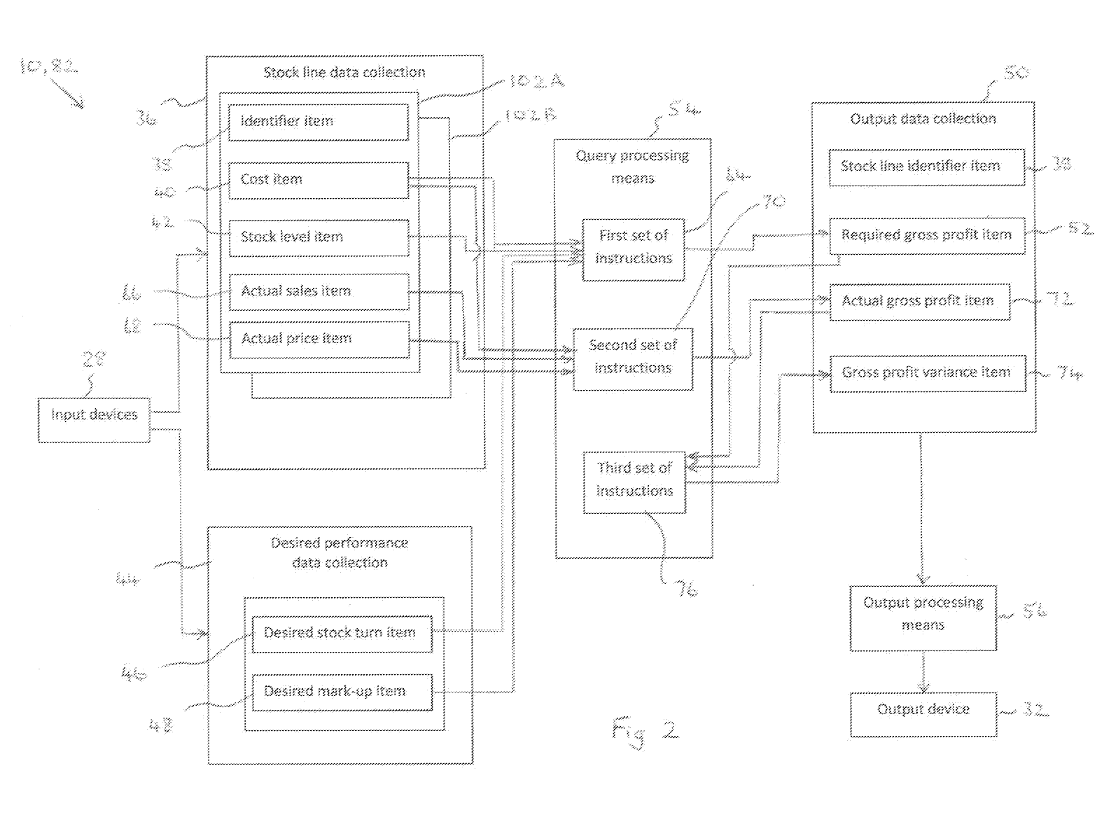

The memory device 30 includes stock line data collections 36, each stock line data collection 36 relating to one of the stock lines 22. As shown in FIG. 2, each stock line data collection 36 could include a plurality of period stock line data collections 102A, 102B, each of which relates to a different predetermined time period 88.

Each stock line data collection 36 includes the respective identifier item 38 unique to the stock line 22, a cost item 40 relating to the cost incurred per stock line item 24 in the stock line 22 and a stock level item 42 relating to the number of stock line items 24 in the stock line 22 at a predetermined place, time and date.

In one example, the stock level item 42 could relate to the number of stock level items 42 in the stock holding 14 at a stocktaking or inventory date, or over a preceding time period.

The memory device 30 includes a desired performance data collection 44 which includes a desired stockturn item 46 and a desired mark-up item 48.

The memory device 30 includes an output data collection 50 which includes, for each stock line 22, the stock line identifier item 38 and a required gross profit item 52.

The processor device 34 includes query processing means 54 for generating the required gross profit item 52 for the or each stock line 22 from the respective desired stockturn item 46, the respective desired mark-up item 48, the respective cost item 40 and the respective stock level item 42.

The processor device 34 includes output processing means 56 for causing the output device 32 to output the output data collection 50.

The cost items 40, the stock level item 42, the desired stock turn items 46 and the desired mark-up items 48 comprise numerical values.

In use, as one stock line item 24 passes the first reader 18, the first reader 18 sends a signal 84 to the computer 26 to increase the stock level item 42 by one. Similarly, as one stock line item 24 passes the second reader 20, the second reader 20 sends a signal 86 to the computer 26 to decrease the stock level item 42 by one. Thus the readers 18, 20 update the system 82 so that the stock level item 42 is accurate.

The query processing means 54 include a first set of instructions 64 which generates the required gross profit item 52 for each stock line 22 by performing a calculation including the values of the respective cost item 40, the respective stock level item 42, the respective desired stock turn item 46 and the respective desired mark-up item 48.

In this and following calculations, the term “mark-up” is defined as the value obtained by dividing the selling price by the cost.

The rationale for the calculation performed by the first set of instructions 64 is as follows.

In this example, the required gross profit item 52 relates to the gross profit required over a predetermined time period, which in this example is one week. The weekly required gross profit is referred to below as WRGP.

WRGP=(required weeks unit sale)×(required se ling price−cost)

The required selling price is (cost×desired mark-up). Substituting into the above equation gives:

WRGP=(required weeks unit sale)×[(cost×desired mark-up)−cost]

Rewriting this gives:

WRGP=(required weeks unit sale)×(cost)×[desired mark-up−1]

As it stands this formula cannot be evaluated, as the “required weeks unit sale” is not a readily available parameter.

However, Desired Stockturn is a parameter that is set at a budget stage, or at a business or corporate planning level and can be defined as:

Desired stockturn=required weeks unit sale×52/stock level

Rearranging this gives:

Required weeks unit sale=(desired stockturn×stock level)/52

Substituting this into the above equation gives:

WRGP=Desired stockturn×stock level×(1/52)×cost×[desired mark-up−1].

The parameter [desired mark-up−1] is a profitability parameter based on the desired mark-up.

Following this rationale, it is possible to calculate the required gross profit item 52 from the values of the cost item 40, the stock level item 42, the desired stockturn item 46 and the desired mark-up item 48.

Advantageously, these values are readily available. The cost item 40 can be taken from management accounts. The stock level item 42 can be taken from management accounts or stock taking records. The desired stockturn item 46 and the desired mark-up item 48 can be taken from planning or budgeting information.

It will be appreciated that the predetermined time period could be any convenient or suitable period, such as, for example, daily, weekly, monthly or annually.

Each stock line data collection 36 includes an actual sales item 66, which is a numerical value, and which relates to the actual sales achieved of the respective stock line 22 in the predetermined period 88.

Each stock line data collection 36 includes an actual price item 68, which is a numerical value, and which relates to the actual price achieved of the respective stock line 22 in the predetermined period 88.

The query processing means 54 include a second set of instructions 70, which generate an actual gross profit item 72 for each stock line 22 in the predetermined period 88 by performing a calculation including the respective cost item 40, the respective actual price item 68 and the respective actual sales item 66.

The calculation performed by the second set of instructions 70 is as follows. Again, in this example the predetermined time period 88 has been taken as weekly. The weekly actual gross profit is referred to as WAGP.

WAGP=weeks actual unit sales×(selling price−cost)

Following this rationale, it is possible to calculate the actual gross profit item 72 from the values of the cost item 40, the actual price item 68 and the actual sales item 66.

Advantageously, these values are all readily available from management accounts.

The output data collection 50 includes, for each stock line 22, the actual gross profit item 72, which is a numerical value.

The query processing means 54 include a third set of instructions 76, which generates a gross profit variance item 74 for each stock line 22 by performing a calculation including the required gross profit item 52 and the actual gross profit item 72.

The calculation performed by the third set of instructions 76 is as follows:

Gross profit variance=actual gross profit−required gross profit

The output data collection 50 includes, for each stock line 22, the gross profit variance item 74, which is a numerical value.

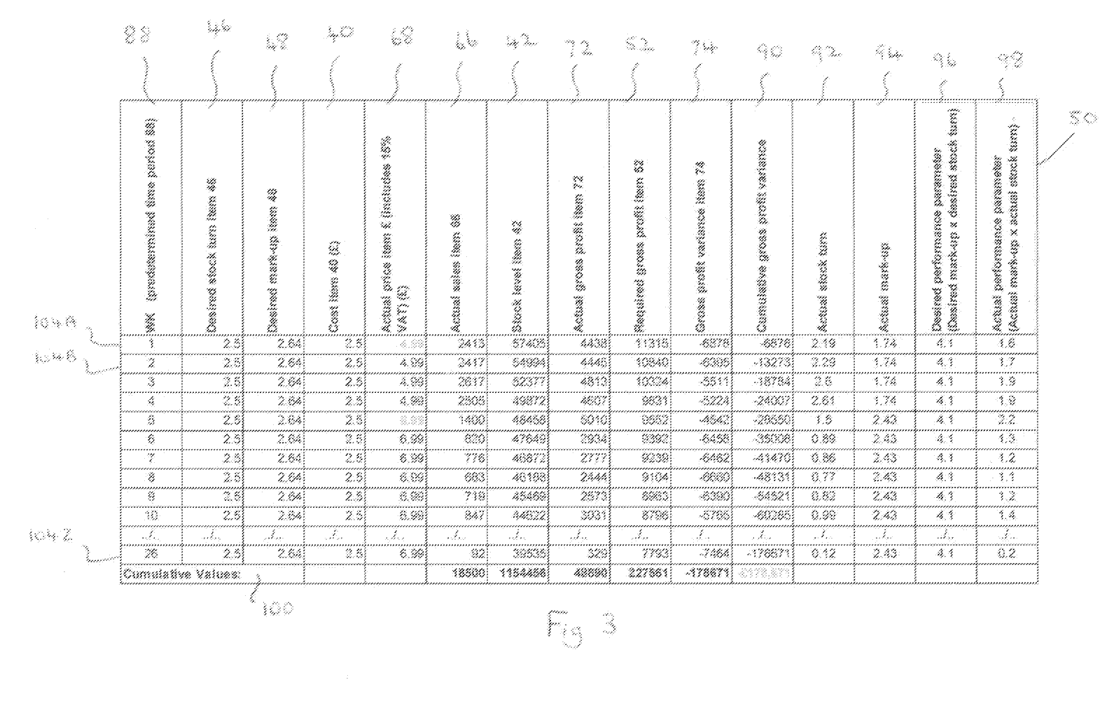

FIG. 3 shows an example of the output data collection 50 for one of the stock lines 22 as might be presented on the display screen 62 or printed out by the printer 60. In this Figure, the numeric references relate to the column referenced and the entries therein. The output data collection 50 includes a plurality of period output data collections 104A, 104B, . . . , 104Z (only a few of which have been referenced), each of which relates to a different one of the predetermined time periods 88.

The query processing means 54 could include other sets of instructions (not shown) which could generate other items in the output data collection 50. The other items could include, for example, an actual stock turn item 92 and an actual mark-up item 94. These could in turn be used to calculate performance parameters. The performance parameters shown in FIG. 3 are calculated as follows:

Performance parameter=mark-up×stock turn

This is a useful parameter as it reflects gross profitability in terms of mark-up and stock turn, and is calculated in FIG. 3 as a desired performance parameter 96 and, for comparison, an actual performance parameter 98.

Other items which could also calculated include a cumulative gross profit variance 90 which provides a running total of the gross profit variance item 74 and cumulative values (indicated by the row with the numeric reference 100) in which values of the actual sales items 66, the actual gross profit items 72, the required gross profit items 52 and the gross profit variance items 74 are totalled for all of the time periods 88 under consideration.

Similar data collections can be generated for different stock lines 22, and comparisons made between the items for the different stock lines.

The apparatus and method of the invention enables a true financial performance evaluation of the stock lines that can be readily compared to budgetary expectations, and which, as a result, can lead to better forecasting and decision making. The data generated can also to be used to assess the effect of changes made. For example, in FIG. 3, the actual price item 68 is increased from £4.99 to £6.99 in week 5. Initially, although this reduces the actual sales item 66, the actual gross profit item 72 is increased, but by week 6 the actual sales item 66 has dropped even further and the actual gross profit item 72 is now reduced.

Advantageously, the apparatus and method of the invention provides an evaluation on the basis of agreed parameters for the desired stock turn and mark-up, and thus enables a simple and fair comparison to be made of the performance of different stock lines over different time periods across a business. In a large business with many stock lines, this allows the rapid identification of successful products and strategies and permits action to be taken in the case of underperforming products and failing strategies.

The stock management apparatus and method of the invention can be easily integrated into existing stock management and accounting systems.

What is claimed is:

1. A stock system, the system including stock management apparatus, the apparatus comprising:
an input device arrangement, a memory device, an output device arrangement and a processor device;
the memory device including a stock line data collection, the stock line data collection relating to a stock line;
the stock line data collection including an identifier item unique to the stock line, a cost item relating to the cost incurred per stock item in the stock line and a stock level item relating to the number of stock line items in the stock line at a predetermined place, time and date;
the memory device including a desired performance data collection which includes a desired stockturn item and a desired mark-up item;
the memory device including an output data collection including, for the stock line, a required gross profit item;
the processor device including query processing means for generating the required gross profit item for the stock line from the desired stockturn item, the desired mark-up item, the cost item and the stock level item for the stock line; and
the processor device including output processing means for causing the output device to output the output data collection.

2. The system according to claim 1, wherein the cost item, the stock level item, the desired stock turn item and the desired mark-up item comprise numerical values.

3. The system according to claim 1, wherein the stock line data collection relates to the stock line over a predetermined time period.

4. The system according to claim 1, wherein the query processing means include a first set of instructions, which generates the required gross profit for the stock line by performing a calculation in which the values of the cost item, the stock level item, the desired stock turn item and a profitability parameter based on the desired mark-up item are multiplied together.

5. The system according to claim 1, wherein the stock line data collection includes an actual sales item, which is a numerical value, which relates to the actual sales achieved of the stock line in a predetermined period.

6. The system according to claim 1, wherein the stock line data collection includes an actual price item, which is a numerical value, which relates to the actual price achieved of the stock line in the predetermined period.

7. The system according to claim 1, wherein the stock line data collection includes an actual sales item, which is a numerical value, which relates to the actual sales achieved of the stock line in a predetermined period, an actual price item, which is a numerical value, which relates to the actual price achieved of the stock line in the predetermined period, and the query processing means include a second set of instructions, which generates an actual gross profit item for the stock line in the predetermined period by performing a calculation including the cost item, the actual price item and the actual sales item.

8. The system according to claim 1, wherein the stock line data collection includes an actual sales item, which is a numerical value, which relates to the actual sales achieved of the stock line in a predetermined period, and an actual price item, which is a numerical value, which relates to the actual price achieved of the stock line in the predetermined period; the query processing means include a second set of instructions, which generates an actual gross profit item for the stock line in the predetermined period by performing a calculation including the cost item, the actual price item and the actual sales item; and the output data collection includes, for the stock line, the actual gross profit item, which is a numerical value.

9. The system according to claim 1, wherein the stock line data collection includes an actual sales item, which is a numerical value, which relates to the actual sales achieved of the stock line in a predetermined period and an actual price item, which is a numerical value, which relates to the actual price achieved of the stock line in the predetermined period; the query processing means include a second set of instructions, which generates an actual gross profit item for the stock line in the predetermined period by performing a calculation including the cost item, the actual price item and the actual sales item; and the query processing means include a third set of instructions, which generates a gross profit variance item for the stock line by performing a calculation including the required gross profit item and the actual gross profit item.

10. The system according to claim 1, wherein the stock line data collection includes an actual sales item, which is a numerical value, which relates to the actual sales achieved of the stock line in a predetermined period and an actual price item, which is a numerical value, which relates to the actual price achieved of the stock line in the predetermined period; the query processing means include a second set of instructions, which generates an actual gross profit item for the stock line in the predetermined period by performing a calculation including the cost item, the actual price item and the actual sales item; the query processing means include a third set of instructions, which generates a gross profit variance item for the stock line by performing a calculation including the required gross profit item and the actual gross profit item; and the output data collection includes, for the stock line, the gross profit variance item, which is a numerical value.

11. The system according to claim 1, in which each stock line data collection includes a plurality of period stock line data collections, each of which relates to a different predetermined time period.

12. The system according to claim 1, wherein the memory apparatus includes a plurality of stock line data collections, and each stock line data collection relates to a different stock line.

13. The system according to claim 1, wherein the stock system includes an upstream stock source, a stock holding, and a downstream stock destination.

14. The system according to claim 1, wherein the stock system includes an upstream stock source, a stock holding, and a downstream stock destination and the input device arrangement comprises a first reader located between the upstream stock source and the stock holding.

15. The system according to claim 1, wherein the stock system includes an upstream stock source, a stock holding, and a downstream stock destination and the input device arrangement comprises a second reader located between the stock holding and the downstream stock destination.

16. The system according to claim 1, wherein the stock system includes an upstream stock source, a stock holding, and a downstream stock destination; the input device arrangement comprises a first reader located between the upstream stock source and the stock holding and a second reader located between the stock holding and the downstream stock destination; and the apparatus includes one or more stock line items, the or each of which is movable in use between the upstream stock source and the stock holding via the first reader and is movable between the stock holding and the downstream stock destination via the second reader.

17. The system according to claim 1, further including a stock management computer program, the program comprising computer program code means which, when loaded into a processor device, causes the processor device to perform as part of the above described system.

18. The system according to claim 17, wherein the computer program is embodied on a computer readable medium, which, when loaded into a processor device causes the processor device to perform as part of the above described system.

19. A method of managing stock in a stock system, the method including providing a stock system including stock management apparatus, the apparatus including:
an input device arrangement, a memory device, an output device arrangement and a processor device;
the memory device including a stock line data collection, the stock line data collection relating to a stock line;
the stock line data collection including an identifier item unique to the stock line, a cost item relating to the cost incurred per stock item in the stock line and a stock level item relating to the number of stock line items in the stock line at a predetermined place, time and date;
the memory device including a desired performance data collection which includes a desired stockturn item and a desired mark-up item;
the memory device including an output data collection including, for the stock line, a required gross profit item;
the processor device including query processing means for generating the required gross profit item for the stock line from the desired stockturn item, the desired mark-up item, the cost item and the stock level item for the stock line; and
the processor device including output processing means for causing the output device to output the output data collection.

20. The method of claim 19, further including a stock management computer program embodied on a computer readable medium, the program comprising computer program code means which, when loaded into a processor device, causes the processor device to perform as part of the above described method.
